(19) United States
(12) Patent Application Publication
(10) Pub. No.: US 2024/0380482 A1
(43) Pub. Date: Nov. 14, 2024

(54) CHARGING EXCHANGE FOR AMBIENT POWER DEVICES

(71) Applicant: Cisco Technology, Inc., San Jose, CA (US)

(72) Inventors: Jerome Henry, Pittsboro, NC (US); Robert E. Barton, Richmond (CA); Juan Carlos Zuniga, Montreal (CA); Indermeet Gandhi, San Jose, CA (US)

(73) Assignee: Cisco Technology, Inc., San Jose, CA (US)

(21) Appl. No.: 18/497,126

(22) Filed: Oct. 30, 2023

Related U.S. Application Data
(60) Provisional application No. 63/502,084, filed on May 13, 2023.

(51) Int. Cl. H04B 7/22; H02J 50/20

(52) U.S. Cl. CPC H04B 7/22; H02J 50/20

(57) ABSTRACT

Charging for Ambient Power (AMP) devices and, in particular, AMP Backscatter Devices (BKDs) may be provided. AMP device charging may include a transmitting device transmitting an initial charging frame, the initial charging frame comprising a payload for charging. The transmitting device may detect a BKD in response to transmitting the initial charging frame. The transmitting device may then determine a new payload for a new charging frame to charge the BKD and transmit the new charging frame to charge to the BKD.

### RELATED APPLICATION

Under provisions of 35 U.S.C. § 119 (e), Applicant claims benefit of U.S. Provisional Application No. 63/502,084, filed May 13, 2023, which is incorporated herein by reference.

### TECHNICAL FIELD

The present disclosure relates generally to providing charging for Ambient Power (AMP) devices and, in particular, AMP Backscatter Devices (BKDs).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of a charging frame for Backscatter Device (BKD) charging;

FIG. 2 is a block diagram of an operating environment for BKD charging;

FIG. 3 is a flow chart of a method for BKD charging; and

FIG. 4 is a block diagram of a computing device.

### DETAILED DESCRIPTION

### Overview

Charging for Ambient Power (AMP) devices and, in particular, AMP Backscatter Devices (BKDs) may be provided. AMP device charging may include a transmitting device transmitting an initial charging frame, the initial charging frame comprising a payload for charging. The transmitting device may detect a BKD in response to transmitting the initial charging frame. The transmitting device may then determine a new payload for a new charging frame to charge the BKD and transmit the new charging frame to charge to the BKD.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Backscatter Devices (BKDs) are devices that may be limited in power and/or processing capabilities. BKDs may have an external battery, have just a limited power supply, and/or may be passive devices. For example, Ambient Power (AMP) BKDs can use Radio Frequency (RF) signals to transmit data without a power source such as a battery or a connection to electricity or use the RF signals to charge the power source. BKDs may be Internet of Things (IoT) devices in some examples.

BKDs may use an antenna to receive a RF signal, use the RF signal for excitation (e.g., convert the RF signal into electricity), and/or modulate or otherwise modify and reflect the RF signal with encoded data. Other devices can receive a reflected RF signal transmitted by a BKD to determine the data the BKD is sending. BKD operations may be described in documents and standards from the Institute of Electrical and Electronics Engineers (IEEE). For example, the IEEE AMP topic interest group and the IEEE 802.11 standard may describe and the operations of BKDs.

Fully passive devices such as RF Identification (RFID) tags usually have different banks of memory. In normal operation, an RFID reader (e.g., a scanner) may be used to excite the RFID tag, and the RFID tag may respond with a pre-configured message that includes the information stored on one or more of the tag's memory banks. Other types of BKD can include sensors, which can store the sensor data on its memory bank and transmit the sensor data when the sensor receives an excitation signal, for example from a scanner.

BKDs may be grouped into two types of devices, passive BKDs (e.g., BKDs directly reflect the signal the device receives after performing backscattering), and active BKDs, devices that include some power source, such as a capacitor, and can thus charge using received signals until the BKD can send its own frames. Both passive BKDs and active BKD may require energy to be sent from a source to the BKD, such as by an Access Point (AP). A typical frame (such as a regular Orthogonal Frequency Division Multiplexing (OFDM)-modulated frame) may not provide sufficient energy for the operation of a BKD.

Additionally, a passive BKD may modulate a charging signal to act as a source of interference to demodulate a reflected passive BKD signal when the BKD receives a charging signal at the same time the BKD performs backscattering. For example, the interference of the modulated charging frame may occur at the same time as the BKD reflects the signal back, at the same frequency for example. Thus, a new charging frame and charging scheme is described for BKD charging (e.g., excitation) herein to provide sufficient energy to BKDs and avoid interference.

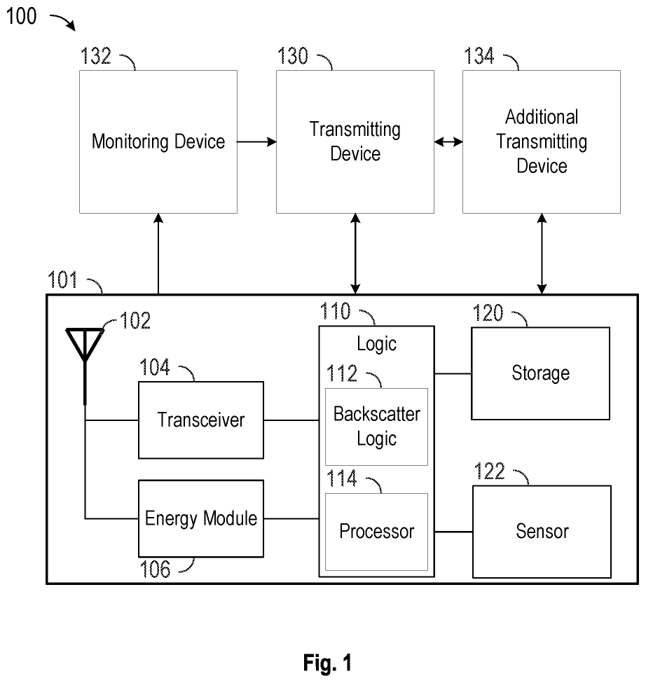

FIG. 1 is a block diagram of an operating environment 100 for BKD charging. The operating environment 100 may include a BKD 101, a transmitting device 130, and a monitoring device 132. The BKD 101 may be a passive BKD or an active BKD. The transmitting device 130 may be any device capable of transmitting signals to the BKD 101. The transmitting device 130 may transmit signals to the BKD 101 to enable the BKD 101 to charge and/or perform backscattering or otherwise transmit signals. The monitoring device 132 may detect or otherwise receive signals the BKD 101 transmits and relay the signals to the transmitting device 130 and/or the transmitting device 130 may directly detect or otherwise receive the signals the BKD 101 transmits. The transmitting device 130 and/or the monitoring device 132 may be APs in some examples.

The BKD 101 may include an antenna 102, a transceiver 104, an energy module 106, logic 110, storage 120, and a sensor 122. The logic 110 may include backscatter logic 112 and processor 114. The BKD 101 may include more (e.g., a capacitor) or fewer components in other examples.

The antenna 102 and the transceiver 104 may operate to transmit and/or receive signals, including receiving charging signals and transmitting signals in response to receiving charging signals for example. The energy module 106 may convert a signal the BKD 101 receives, from the transmitting device 130 for example, into electric energy the BKD 101 can use. For example, the energy module 106 may provide electric energy to the transceiver 104, logic 110 (e.g., the backscatter logic 112 and/or the processor 114), storage 120, and/or sensor 122 to enable the components to operate to operate.

The logic 110 may include one or more modules (e.g., the backscatter logic 112) and/or one or more processing units (e.g., the processor 114). The backscatter logic 112 may include components for the BKD 101 to perform backscattering or otherwise transmit signals. For example, the BKD 101 may use the backscatter logic 112 to modulate or otherwise modify a signal (e.g., a signal the BKD 101 receives) to encode data onto the signal, thereby generating a new signal that includes the encoded data. The BKD 101 can transmit the new signal with the encoded data to other devices by backscattering or otherwise reflecting the new signal. In some examples, the backscatter logic 112 may be a transponder or one of its components may be a transponder. The processor 114 may control the operation of the BKD 101, including the operation of the transceiver 104, the energy module 106, the backscatter logic 112, the storage 120, and/or the sensor 122. The processor 114 may be one or more conventional processors, multi-core processors, microprocessors, microcontrollers, and/or the like.

The storage 120 may store data the BKD 101 may encode and transmit to other devices. For example, the sensor 122 may collect data, and the storage 120 may store the sensor data. The BKD 101 may then transmit the sensor data. Additionally, the storage 120 may store data and/or receive requests from the backscatter logic 112 so the backscatter can determine how to modulate a signal and determine and/or retrieve data to encode on a signal. The storage 120 may also store data and/or receive requests from the processor 114 so the processor 114 can determine how to instruct the BKD 101 to operate (e.g., to instruct the backscatter logic 112 how to modulate a signal and/or what data to encode on a signal, instruct the transceiver 104 to transmit and/or receive signals, etc.).

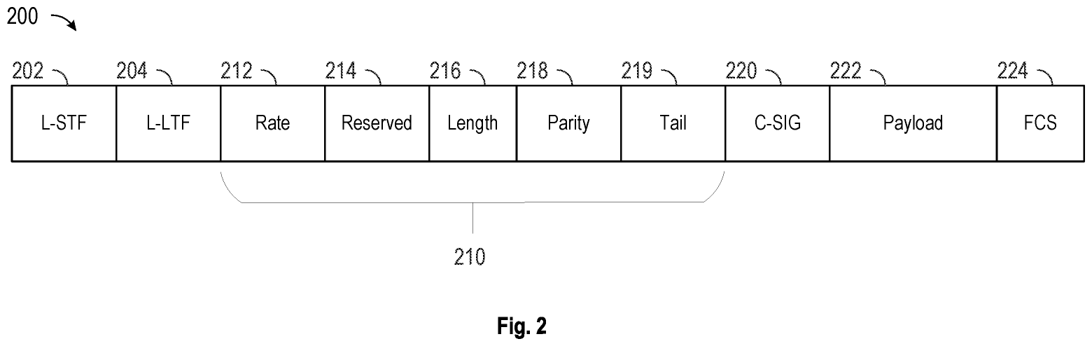

FIG. 2 is a block diagram of a charging frame 200 for BKD charging. The charging frame 200 may be a Physical Layer Protocol Data Unit (PPDU) or a portion of a PPDU as described by IEEE 802.11 in some examples. The charging frame 200 may be structured and/or transmitted (e.g., by the transmitting device 130) to enable BKDs (e.g., the BKD 101) to charge. For example, the transmitting device 130 may transmit the charging frame 200 in a way and/or structure the charging frame 200 to provide a desired amount of energy (e.g., the maximum possible energy) to enable the BKD 101 to charge. The transmitting device 130 may transmit multiple charging frames 200 to the BKD 101 to incrementally increase the power the BKD 101 can store. For example, the BKD 101 may require two or more charging frames 200 to have enough energy to operate (e.g., perform backscattering or otherwise transmit). The charging frame 200 may include a Legacy Short Training Field (L-STF) 202, a Legacy Long Training Field (L-LTF) 204, a Legacy Signal Field (L-SIG) 210, a Charge Signal Field (C-SIG) 220, a payload 222, and a Frame Check Sequence (FCS) 224. The L-SIG 210 may include a rate field 212, a reserved field 214, a length field 216, a parity field 218, and a tail field 219.

The L-STF 202 may signal to or otherwise enable devices, such as BKDs, to determine to begin packet detection, perform automatic gain control, perform frequency offset estimation, perform initial time synchronization, and/or the like. The L-LTF 204 may signal to or otherwise enable devices, such as BKDs, to perform channel estimation, perform a more accurate frequency offset estimation compared to the estimation performed when the L-STF 202 is received, perform more accurate time synchronization compared to the estimation performed when the L-STF 202 is received, and/or the like. Thus, devices, including BKDs in some examples, may use the L-STF 202 and the L-LTF 204 to detect the charging frame 200.

The rate field 212 may indicate the transfer rate of rate of the charging frame 200. For example, the rate field 212 may be four bits and a value may be set using the four bits to indicate the transfer rate. The reserved field 214 may be one or more bits, typically one bit, and may be set to indicate to devices that the charging frame 200 may be used for BKD charging or excitation. The length field 216 may indicate the length of the rest of the charging frame 200 (e.g., the length of the C-SIG 220, the length of the payload 222, and/or the like). The length field 216 may be twelve bits. The parity field 218 may be a single bit that may be set indicate whether an error has occurred. Therefore, devices may validate the integrity of the charging frame 200 using the parity field 218. The tail field 219 may be a sequence of bits (e.g., six bits) that may be set indicate the end of the L-SIG 210. Additionally, the transmitting device 130, when transmitting the charging frame 200, may set the tail field 219 to indicate to BKDs that the charging frame 200 may be used for charging or excitation. For example, the transmitting device 130 may set one of the tail field 219 bits to indicate to the BKD 101 that the charging frame 200 may be used for charging. Thus, the transmitting device 130 may set or otherwise use the reserved field 214 and/or the tail field 219 to indicate the charging frame 200 may be used for charging. In other embodiments, the transmitting device 130 may not use the L-SIG 210 (e.g., via the reserved field 214 and/or the tail field 219) to indicate the charging frame 200 may be used for charging.

The payload 222 may directly follow the C-SIG 220 or the tail field 219 when the C-SIG 220 is not included in the charging frame 200. The payload 222 may be a sequence repeated for the duration of the charging frame 200. For example, the payload 222 may be a series of bits (e.g., 010101 . . . , a series of zeros, a series of ones, etc.). The payload 222 may be modulated using methods to minimize or otherwise reduce interference. For example, the payload 222 may be modulated using Direct-Sequence Spread Spectrum (DSSS), Binary Phase Shift Keying (BPSK), and/or the like. DSSS and/or BPSK may be advantageously utilized for modulation and for maximizing or otherwise increasing the energy of the charging frame 200 transmission (e.g., at the frequency center), enabling the transmitting device 130 to deliver more energy to a BKD. The duration of the payload 222 may depend on the amount of energy that a BKD may need and/or is capable of using. For example, the transmitting device 130 may determine how much energy the BKD 101 or some other target BKD needs and/or is capable of using based on communications enabled by the C-SIG 220, other communications with the BKD 101, transmissions of the BKD 101, previous transmissions of the charging frame 200, receiving information about the BKD 101 (e.g., device ID, device type, energy storage capabilities, etc.), and/or the like. The transmitting device 130 may then determine the duration of the payload 222 based on the determination of how much energy the BKD 101 needs and/or is capable of using.

The FCS 224 may be included in the charging frame 200 to conclude the charging frame 200. The FCS 224 may be included for backwards compatibility. The FCS 224 may contain a value calculated by the transmitting device 130 based on the data in the charging frame 200. When device receives the charging frame 200, the device may recalculate the value based on the data in the charging frame 200 and compare the recalculated value to the value in the FCS 224 for error detection. If the recalculated value and the value in the FCS 224 are different, the receiving device may determine there is an error and discard the charging frame 200.

The C-SIG 220 may be an optional negotiation field inserted after the L-SIG 210. The C-SIG 220 may enable the transmitting device 130 and the BKD 101 to exchange information associated with charging. The transmitting device 130 and the BKD 101 may exchange information via an intermediate device such as a relay in some examples. In some examples, the transmitting device 130 may only include the C-SIG 220 when sending a first charging frame 200 to a BKD, such as the BKD 101. In other examples, the transmitting device 130 may include C-SIG 220 in each charging frame 200 the transmitting device 130 transmits.

In certain embodiments, the transmitting device 130 may send an initial charging frame 200 that includes an empty C-SIG 220 (e.g., a series of 0s, 1s, or 01s) or includes a trigger sequence. The C-SIG 220 may contain the trigger sequence. The transmitting device 130 may also structure the initial charging frame 200 to have a short duration (e.g., a short payload 222). The transmitting device 130 may transmit the initial charging frame 200 to detect the presence of BKDs in the operating environment 100, such as the presence of the BKD 101.

After transmitting the initial charging frame 200, the transmitting device 130 may detect the BKD 101 by detecting modulated energy reflected by the BKD 101 because the reflected energy may in another frequency than the radiated energy once the BKD 101 performs backscatter and encodes data on the signal. Thus, the transmitting device 130 may monitor for one or more frequencies corresponding to signal(s) the BKD 101 may transmit (e.g. the upper part of a wide channel). In some examples, instead of the transmitting device 130 directly detecting or otherwise receiving signals from the BKD 101, the monitoring device 132 may detect the signals the BKD 101 transmits and may relay the BKD signals or the payload of the BKD signals to the transmitting device 130. The monitoring device 132 may wait to relay the BKD signals or payloads to the transmitting device 130 until the charging frame 200 transmission is completed.

When the BKD 101 is a passive BKD, the BKD 101 may perform backscattering and reflect the signal before the initial charging frame 200 concludes. Thus, the transmitting device 130 may detect the presence of one or more passive BKDs while transmitting the initial charging frame 200. When the BKD 101 is an active BKD, the BKD 101 may respond to the initial charging frame 200 with a new frame The C-SIG 220 of the new frame may include an identifier associated with the BKD 101. The C-SIG 220 may additionally include feedback such as configuration requirements of the BKD 101 in some examples. The configuration requirements may include information on the effective power received in response to the reception of the initial charging frame 200 (e.g., how much power the BKD 101 received, how effective the initial charging frame 200 was, how much additional power the BKD 101 may need or request to receive, and/or the like). The new frame may also include a proposed recharging schedule to the transmitting device 130, allowing the transmitting device 130 to determine when to transmit charging frames 200 to the BKD 101 (e.g., developing a schedule to recharge the BKD 101 via charging frames 200). When multiple BKDs are in the operating environment 100, the requested amount of power, additional power requirements, charging frame effectiveness, and/or charging schedules may differ (e.g., depending on each BKD's energy use profile, operation, etc.).

The transmitting device 130 may use feedback (e.g., configuration requirements, etc.) from the BKD 101 to determine the structure of subsequent charging frame(s) 200. For example, the transmitting device 130 may set the duration of the next charging frame 200 (e.g., the payload 222) based on the feedback (e.g. setting a longer duration and/or or increasing the power while staying within regulatory limits if the transmitting device 130 determines that the previous frame was not effective enough to charge the BKD 101 as the BKD 101 needed or requested; setting a shorter duration and/or reducing the power if the previous frame was above an acceptable power threshold for the BKD 101). The transmitting device 130 may evaluate feedback from the BKD 101 after every charging frame 200, after every charging frame 200 until a sufficient structure of the charging frame 200 is determined for the BKD 101, periodically, until the transmitting device 130 determines charging is complete, until the BKD 101 signals that charging is complete, and/or the like.

In some embodiments, the transmitting device 130 may coordinate with other transmitting devices such as the additional transmitting device 134 to efficiently transmit charging frames 200. For example, the transmitting device 130 may determine that charging the BKD 101 may be more efficient if charging was coordinated between multiple transmitting devices (e.g., both the transmitting device 130 and the additional transmitting device 134 sending charging frames 200) or a better positioned transmitting device (e.g., when the additional transmitting device 134 is closer to the BKD 101 and can more efficiently transmit charging frames 200 to the BKD 101). The transmitting device 130 and additional transmitting device 134 may communicate to enable the transmitting device 130 to determine which devices should transmit charging frames 200 to the BKD 101 for their efficient transmission.

When the transmitting device 130 determines that the additional transmitting device 134 should send charging frames 200 to the BKD 101, whether in addition to the transmitting device 130 sending charging frames 200 in a joint charging sequence or solely the additional transmitting device 134, the transmitting device 130 may send a charging assistance request to the additional transmitting device 134. The charging assistance request may be a specific action frame that identifies the charging frame 200 structure (the payload 222 duration, an amount of charging frames 200 to send, C-SIG content, and/or the like) the additional transmitting device 134 should use. The additional transmitting device 134 may respond to the charging assistance request with a charging assistance response, indicating whether the additional transmitting device 134 accepts or declines the request. When the additional transmitting device 134 accepts the charging assistance request, the additional transmitting device 134 may send charging frames 200 to the BKD 101 in the structure specified by the charging assistance request. In some examples, the additional transmitting device 134 may communicate with the transmitting device 130 to propose modifications to the charging frame 200 structure before sending charging frames 200 to the BKD 101.

When the transmitting device 130 and the additional transmitting device 134 will both be sending charging frames 200 to the BKD 101 in a joint charging sequence, the transmitting device 130 may send a trigger frame to the additional transmitting device 134 to cause the transmitting device 130 and the additional transmitting device 134 to initiate a charging frame 200 at the same time. The transmitting device 130 may transmit a trigger frame for each transmission of a charging frame 200 or there may be an agreed upon schedule to send charging frames 200 after the transmitting device 130 sends the initial trigger frame.

The transmitting device 130 may use feedback from the BKD 101 to determine when to stop a joint charging sequence. The transmitting device 130 can interrupt the joint charging sequence by stopping the transmission of trigger frames and/or sending a new charging assistance request frame indicating a termination request.

When multiple passive BKDs are in the operating environment 100, the BKDs may interfere with each other (e.g., the BKD reflected energy may overlap). Passive BKDs may have the ability to use a mechanism (e.g. a physical or logical device to obfuscate a part of their reflecting coil) so that their reflected signal only modulates part of the energy source received (e.g., a charging frame 200). Thus, only a segment of the reflected frame may include data the passive BKD encodes on the frame. The transmitting device 130 may assign (e.g., via the C-SIG 220) the BKD 101 a segment of the reflected frame to encode data on. The transmitting device 130 may additionally assign other passive BKDs in the operating environment 100 different segments. Thus, the encoded data of the BKDs may be determined because the encoded data of each BKD may not be encoded on overlapping segments of a charging frame 200. The transmitting device 130 may transmit the instruction with an identifier of which BKD the instruction is for. The instruction may be included in the C-SIG 220. The instruction may describe response delay for the associated BKD, and the associated BKD may utilize the response delay to encode data on the assigned segment. For example, the BKD 101 may be assigned a first segment of the payload 222, a second BKD may be assigned a middle segment of the payload 222, and a third BKD may be assigned an end segment of the payload 222. The BKD 101 may use a cache or other delay mechanism to correctly encode data at its assigned segment. During the transmission of a charging frame 200, the BKD 101 and/or the other BKDs may continue to move their caches until they receive the instruction and/or the assigned segment occurs.

The BKD 101 and/or other BKDs may receive the instruction in one charging frame 200 and then know the assigned segment for encoding data for subsequent charging frames 200 and/or other transmissions. The transmitting device 130 can update assigned segments by indicating the identifier of a BKD that should change its assigned segment and therefore change its delay and the new assigned segment. Thus, the identified BKD may adjust its cache accordingly.

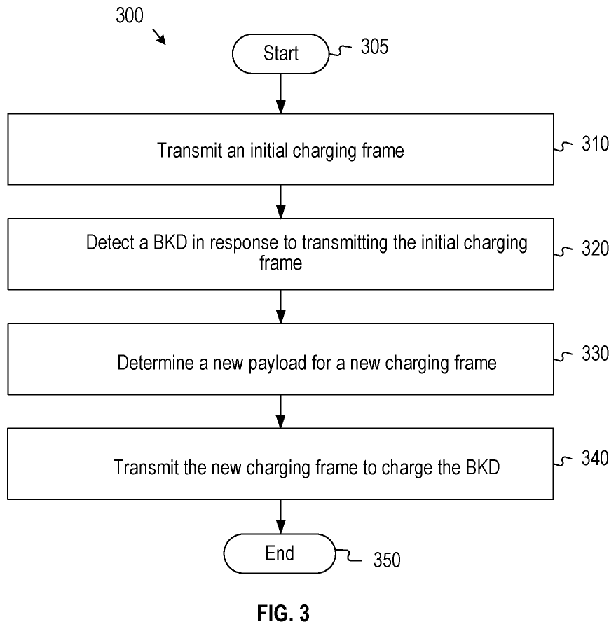

FIG. 3 is a flow chart of a method 300 for BKD charging. The method 300 may begin at starting block 305 and proceed to operation 310. In operation 310, an initial charging frame may be transmitted. For example, the transmitting device 130 may generate and transmit an initial charging frame 200 comprising a payload 222 for charging the BKD 101. The initial charging frame 200 may include an empty C-SIG 220 and/or a trigger sequence.

In operation 320, a BKD may be detected in response to transmitting the initial charging frame. For example, the transmitting device 130 and/or the monitoring device 132 may detect the BKD 101 by detecting modulated energy reflected by the BKD 101 in response to the BKD 101 receiving the initial charging frame 200.

In operation 330, a new payload may be determined for a new charging frame to charge the BKD. For example, the transmitting device 130 may receive feedback from the BKD 101, such as an identifier, configuration requirements and/or the like. The transmitting device 130 may determine a new payload 222 based on the feedback.

In operation 340, the new charging frame may be transmitted to charge to the BKD. For example, the transmitting device 130 may transmit the new charging frame 200 so the BKD 101 can charge or otherwise operate. The method 300 may conclude at ending block 350.

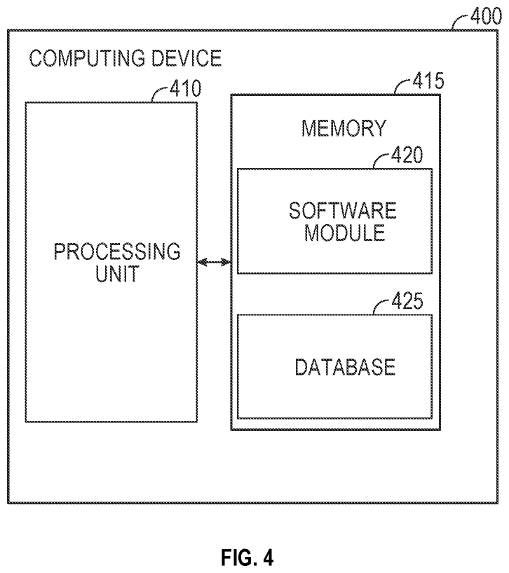

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for AMP device charging with respect to FIG. 1, FIG. 2, and FIG. 3. Computing device 400, for example, may provide an operating environment for the BKD 101, the transmitting device 130, the monitoring device 132, the additional transmitting device 134, and the like. The BKD 101, the transmitting device 130, the monitoring device 132, the additional transmitting device 134, and the like may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
transmitting an initial charging frame, the initial charging frame comprising a payload for charging;
detecting a Backscatter Device (BKD) in response to transmitting the initial charging frame;
determining a new payload for a new charging frame to charge the BKD; and
transmitting the new charging frame to charge to the BKD.

2. The method of claim 1, wherein one or both of the initial charging frame and the new charging frame, comprises any one of: (i) a Legacy Short Training Field (L-STF); (ii) a Legacy Long Training Field (L-LTF); (iii) a Legacy Signal Field (L-SIG); (iv) a Charge Signal Field (C-SIG) operable to enable communication with the BKD; (v) a Frame Check Sequence (FCS); or (vi) any combination of (i)-(v).

3. The method of claim 2, further comprising:
setting a field of one or both of an initial charging frame L-SIG and a new charging frame L-SIG to indicate one or both of the initial charging frame and the new charging frame can used for charging.

4. The method of claim 1, further comprising:
modulating the new payload.

5. The method of claim 1, further comprising:
receiving feedback from the BKD;
in response to the feedback, generating an additional charging frame, comprising:
when the new charging frame was not effective to charge the BKD, structuring the additional charging frame to have one or both of a longer duration and increased power compared to the new charging frame, and
when the new charging frame was above a power threshold, structuring the additional charging frame to have one or both of a shorter duration and a reduced power compared to the new charging frame; and
transmitting the additional charging frame.

6. The method of claim 1, further comprising:
coordinating with an additional transmitting device to charge the BKD, wherein the coordinating comprises:
sending a charging assistance request to the additional transmitting device;
receiving a charging assistance response accepting the charging assistance request from the additional transmitting device; and
sending a trigger frame to the additional transmitting device to jointly transmit additional charging frames with the additional transmitting device.

7. The method of claim 1, further comprising:
detecting one or more additional BKDs; and
assigning segments for encoding data to the BKD and the one or more BKDs.

8. A system comprising:
a memory storage; and
a processing unit coupled to the memory storage, wherein the processing unit is operative to:
transmit an initial charging frame, the initial charging frame comprising a payload for charging;
detect a Backscatter Device (BKD) in response to transmitting the initial charging frame;
determine a new payload for a new charging frame to charge the BKD; and
transmit the new charging frame to charge to the BKD.

9. The system of claim 8, wherein one or both of the initial charging frame and the new charging frame, comprises any one of: (i) a Legacy Short Training Field (L-STF); (ii) a Legacy Long Training Field (L-LTF); (iii) a Legacy Signal Field (L-SIG); (iv) a Charge Signal Field (C-SIG) operable to enable communication with the BKD; (v) a Frame Check Sequence (FCS); or (vi) any combination of (i)-(v).

10. The system of claim 9, the processing unit being further operative to:
set a field of one or both of an initial charging frame L-SIG and a new charging frame L-SIG to indicate one or both of the initial charging frame and the new charging frame can used for charging.

11. The system of claim 8, the processing unit being further operative to:
modulate the new payload.

12. The system of claim 8, the processing unit being further operative to:
receive feedback from the BKD;
in response to the feedback, generate an additional charging frame, comprising:
when the new charging frame was not effective to charge the BKD, structure the additional charging frame to have one or both of a longer duration and increased power compared to the new charging frame, and
when the new charging frame was above a power threshold, structure the additional charging frame to have one or both of a shorter duration and a reduced power compared to the new charging frame; and
transmit the additional charging frame.

13. The system of claim 8, the processing unit being further operative to:
coordinate with an additional transmitting device to charge the BKD, wherein the coordinating comprises:
send a charging assistance request to the additional transmitting device;
receive a charging assistance response accepting the charging assistance request from the additional transmitting device; and
send a trigger frame to the additional transmitting device to jointly transmit additional charging frames with the additional transmitting device.

14. The system of claim 8, the processing unit being further operative to:
detect one or more additional BKDs; and
assign segments for encoding data to the BKD and the one or more BKDs.

15. A non-transitory computer-readable medium that stores a set of instructions which when executed perform a method executed by the set of instructions comprising:
transmitting an initial charging frame, the initial charging frame comprising a payload for charging;
detecting a Backscatter Device (BKD) in response to transmitting the initial charging frame;
determining a new payload for a new charging frame to charge the BKD; and
transmitting the new charging frame to charge to the BKD.

16. The non-transitory computer-readable medium of claim 15, wherein one or both of the initial charging frame and the new charging frame, comprises any one of: (i) a Legacy Short Training Field (L-STF); (ii) a Legacy Long Training Field (L-LTF); (iii) a Legacy Signal Field (L-SIG); (iv) a Charge Signal Field (C-SIG) operable to enable communication with the BKD; (v) a Frame Check Sequence (FCS); or (vi) any combination of (i)-(v).

17. The non-transitory computer-readable medium of claim 15, the method executed by the set of instructions further comprising:
modulating the new payload.

18. The non-transitory computer-readable medium of claim 15, the method executed by the set of instructions further comprising:
receiving feedback from the BKD;
in response to the feedback, generating an additional charging frame, comprising:
when the new charging frame was not effective to charge the BKD, structuring the additional charging frame to have one or both of a longer duration and increased power compared to the new charging frame, and
when the new charging frame was above a power threshold, structuring the additional charging frame to have one or both of a shorter duration and a reduced power compared to the new charging frame; and
transmitting the additional charging frame.

19. The non-transitory computer-readable medium of claim 15, the method executed by the set of instructions further comprising:
coordinating with an additional transmitting device to charge the BKD, wherein the coordinating comprises:
sending a charging assistance request to the additional transmitting device;
receiving a charging assistance response accepting the charging assistance request from the additional transmitting device; and
sending a trigger frame to the additional transmitting device to jointly transmit additional charging frames with the additional transmitting device.

20. The non-transitory computer-readable medium of claim 15, the method executed by the set of instructions further comprising:
detecting one or more additional BKDs; and
assigning segments for encoding data to the BKD and the one or more BKDs.
